(19) United States
(12) Patent Application Publication
(10) Pub. No.: US 2018/0139652 A1
(43) Pub. Date: May 17, 2018

(54) BASE STATION AND ACCESS CLASS BARRING METHOD THEREOF AND COMMUNICATION TERMINAL

(71) Applicant: Institute For Information Industry, Taipei (TW)

(72) Inventors: Shao-Yu LIEN, Kaohsiung City (TW); Chiu-Wen CHEN, Taipei City (TW)

(21) Appl. No.: 15/369,788

(22) Filed: Dec. 5, 2016

(30) Foreign Application Priority Data
Nov. 16, 2016 (TW) 105137454

(51) Int. Cl. H04W 28/08; H04W 48/10; H04W 74/08

(52) U.S. Cl. CPC H04W 28/085; H04W 74/0833; H04W 48/10

(57) ABSTRACT

A base station determines at least one access class barring parameter based on load balance of a plurality of random access channels, and broadcasts the at least one access class barring parameter. A communication terminal receives a plurality of access class barring parameters from at least one base station, and then determines a random access channel candidate from the random access channels according to the access class barring parameters and performs a random access procedure on the random access channel candidate. Such an access class barring method can efficiently improve traffic congestions of a plurality of random access channels.

### PRIORITY

This application claims priority to Taiwan Patent Application No. 105137454 filed on Nov. 16, 2016, which is incorporated herein for reference in its entirety.

### FIELD

The present invention relates to a base station and an access class barring method thereof as well as a communication terminal. More particularly, the present invention relates to a base station and an access class barring method thereof as well as a communication terminal that improve traffic congestions of a plurality of random access channels.

### BACKGROUND

In environments where communication apparatuses are deployed at high densities, e.g., in machine-to-machine (M2M) communication architectures or in Internet of Things (IoT) communication architectures, accessing a same base station by a lot of communication apparatuses at the same time will cause problems such as traffic congestions or overloads of the base station. To solve these problems, a random access mechanism called Access Class Barring (ACB) has been proposed by the 3^{rd} Generation Partnership Project (3GPP) for Long-Term Evolution (LTE)/Long-Term Evolution Advanced (LTE-A).

Under the random access mechanism of access class barring, each base station determines and broadcasts information comprising an access class barring parameter (a value ranging between 0 and 1) and an access class barring period, and each communication terminal receiving the information broadcasted by the single base station that is serving the communication terminal will randomly generate an access value (a value ranging between 0 and 1). If the access value randomly generated by the communication terminal is less than or equal to the access class barring parameter broadcasted by the base station that is serving the communication terminal, then the probability that the communication terminal accesses the base station (e.g., via a random access channel) is just the access value. However, if the access value is greater than the access class barring parameter, then the communication terminal will have to wait for the access class barring period and then repeat the aforesaid operations.

Under the aforesaid random access mechanism, each communication terminal can only perform the aforesaid random access procedure on the single base station that is serving the communication terminal. That is, each communication terminal can only generate an access value according to an access class barring parameter broadcasted by the single base station that is serving the communication terminal, and determine the probability that it accesses the base station according to a comparison between the access value and the access class barring parameter. Therefore, the aforesaid random access mechanism can only handle traffic congestions of a single random access channel of an individual base station, but cannot handle traffic congestions of a plurality of random access channels as a whole at the same time.

Accordingly, it is important in the art to solve the problem that the aforesaid random access mechanism can only handle traffic congestions of a single random access channel provided by an individual base station.

### SUMMARY

The disclosure includes a base station. The base station may comprise a processor and a transceiver. The processor may be configured to determine at least one access class barring parameter based on load balance of a plurality of random access channels. Each of the at least one access class barring parameter may correspond to one of the random access channels respectively, and each of the random access channels may be created on a component carrier. The transceiver is configured to broadcast the at least one access class barring parameter so that a communication terminal determines a random access channel candidate from the random access channels and performs a random access procedure on the random access channel candidate.

The disclosure also includes an access class barring method. The access class barring method may comprise the following steps of: determining by a base station at least one access class barring parameter based on load balance of a plurality of random access channels, each of the at least one access class barring parameter corresponding to one of the random access channels respectively, and each of the random access channels being created on a component carrier; and broadcasting by the base station the at least one access class barring parameter so that a communication terminal determines a random access channel candidate from the random access channels and performs a random access procedure on the random access channel candidate.

The disclosure further includes a communication terminal. The communication terminal may comprise a processor and a transceiver. The transceiver may be configured to receive a plurality of access class barring parameters broadcasted by at least one base station. Each of the access class barring parameters may correspond to a random access channel, and each of the random access channels may be created on a component carrier. The processor may be configured to determine a random access channel candidate from the random access channels according to the access class barring parameters and perform a random access procedure on the random access channel candidate.

The disclosure additionally includes a random access method. The random access method may comprise the following steps of: receiving by a communication terminal a plurality of access class barring parameters broadcasted by at least one base station, each of the access class barring parameters corresponding to a random access channel, and each of the random access channels being created on a component carrier; and determining by the communication terminal a random access channel candidate from the random access channels according to the access class barring parameters and performing a random access procedure on the random access channel candidate.

According to the above descriptions, unlike each base station of the conventional access class barring mechanism that can only broadcast one access class barring parameter corresponding to the random access channel provided by itself, the base station and the access class barring method thereof can determine and broadcast at least one (i.e., one or more) access class barring parameter, and each of the at least one access class barring parameter is determined based on load balance of a plurality of random access channels. On the other hand, unlike each communication terminal of the conventional access class barring mechanism that can only perform a random access procedure on a random access channel provided by a single base station that is serving the communication terminal, the communication terminal and the random accessing method thereof can determine a random access channel candidate from a plurality of random access channels according to a plurality of access class barring parameters broadcasted by at least one base station (i.e., one or more base stations), and then perform a random access procedure on the random access channel candidate. Because the present invention can handle traffic congestions of a plurality of random access channels as a whole, the problem that the conventional access class barring mechanism can only handle traffic congestions of a single random access channel provided by an individual base station can be effectively solved.

What described above presents a summary of the present invention (including the problem to be solved, the means to solve the problem and the effect of the present invention) to provide a basic understanding of the present invention. However, this is not intended to encompass all aspects of the present invention. Additionally, what described above is neither intended to identify key or essential elements of the present invention, nor intended to define the scope of the present invention. This summary is provided only to present basic concepts of the present invention in a simple form and as an introduction to the following detailed description.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates architectures of a base station and a communication terminal according to one or more embodiments of the present invention;

FIG. 2 illustrates relationships between the load balance of a plurality of random access channels and access class barring parameters according to one or more embodiments of the present invention;

FIG. 3 illustrates a heterogeneous network communication system according to one or more embodiments of the present invention;

FIG. 4 illustrates a random access mode between a base station and a communication terminal under the heterogeneous network communication system according to one or more embodiments of the present invention;

FIG. 5 illustrates a random access mode between two base stations and a communication terminal under the heterogeneous network communication system according to one or more embodiments of the present invention;

FIG. 6 illustrates a random access mode between three base stations and a communication terminal under the heterogeneous network communication system according to one or more embodiments of the present invention;

FIG. 7 illustrates an access class barring method according to one or more embodiments of the present invention; and

FIG. 8 illustrates a random access method according to one or more embodiments of the present invention.

### DETAILED DESCRIPTION

One or more example embodiments described below are not intended to limit the present invention to any environment, example, embodiment, applications, structures, processes or steps described in these example embodiments. In the attached drawings, elements unrelated to the present invention are omitted from depiction; and dimensions and dimensional relationships among individual elements in the attached drawings are only exemplary examples and are not intended to limit the present invention. Unless stated particularly, same (or similar) element labels may correspond to same (or similar) elements in the following description.

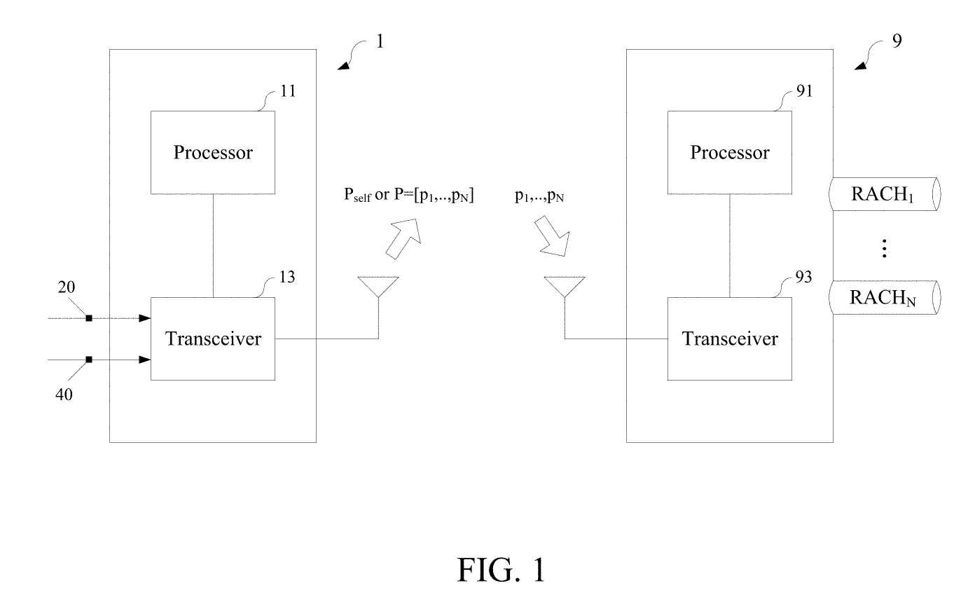

FIG. 1 illustrates architectures of a base station and a communication terminal according to one or more embodiments of the present invention. Referring to FIG. 1, a base station 1 may be any of various types of base stations, for example but not limited to: macrocells, microcells or picocells or the like. A communication terminal 9 may be any of communication terminals with the capability of networking, for example but not limited to: tablet computers, notebook computers, desktop computers, mobile phones, intelligent electrical apparatuses, vehicle-mounted communication apparatuses or the like.

The base station 1 and the communication terminal can be constructed under various communication standards, for example but not limited to: Long Term Evolution (LTE), Long Term Evolution-advanced (LTE-advanced), Universal Mobile Telecommunications System (UMTS), Global System for Mobile Communications (GSM) or the like. The base station 1 and the communication terminal can be used in any environments where communication apparatuses are deployed at high densities, for example but not limited to: in machine-to-machine (M2M) communication architectures or in Internet of Things (IoT) communication architectures.

The base station 1 may comprise a processor 11 and a transceiver 13. The processor 11 may be electrically connected with the transceiver 13 via other elements, i.e., electrically connected with the transceiver 13 indirectly. Alternatively, the processor 11 may be electrically connected with the transceiver 13 without using other elements, i.e., electrically connected with the transceiver 13 directly. Through the direct or indirect connection, data communication can be achieved between the processor 11 and the transceiver 13. The communication terminal 9 may comprise a processor 91 and a transceiver 93. The processor 91 may be electrically connected with the transceiver 93 via other elements, i.e., electrically connected with the transceiver 93 indirectly. Alternatively, the processor 91 may be electrically connected with the transceiver 93 without using other elements, i.e., electrically connected with the transceiver 93 directly. Through the direct or indirect connection, data communication can be achieved between the processor 91 and the transceiver 93.

Each of the base station 1 and the communication terminal 9 may comprise a computing apparatus. The computing apparatus may have computing elements such as a processor and a microprocessor for general purposes, and execute various operations via those computing elements. The computing apparatus may have storage elements such as a memory and/or a storage for general purposes, and store various kinds of data via these storage elements. The computing apparatus may have input/output elements for general purposes, and receive data inputted from users and output data to the users via these input/output elements. The computing apparatus can execute corresponding operations through elements such as the aforesaid computing elements, storage elements and input/output elements according to a processing procedure constructed by software, firmware, programs, algorithms or the like. Each of the processor 11 of the base station 1 and the processor 91 of the communication terminal 9 may be the computing apparatus or a part of the computing apparatus, and is configured to execute all the operations described hereinafter.

Each of the base station 1 and the communication terminal 9 may comprise a transceiving apparatus. The transceiving apparatus may for example include communication elements such as an antenna, an amplifier, a modulator, a demodulator, a detector, an analog-to-digital converter, a digital-to-analog converter or the like. Each of the transceiver 13 of the base station 1 and the transceiver 93 of the communication terminal 9 may be the transceiving apparatus or a part of the transceiving apparatus, and is configured to execute all the operations described hereinafter. Through the operations of the transceiver 13 and the transceiver 93, communication connection can be established between the base station 1 and the communication terminal 9, and data communication can be achieved between the base station 1 and the communication terminal 9 via the communication connection.

The processor 11 of the base station 1 may be configured to determine at least one access class barring parameter based on load balance of a plurality of random access channels.

Each of the at least one access class barring parameter may correspond to one of the random access channels respectively, and each of the random access channels may be created on a component carrier. The processor 11 of the base station 1 may only determine the access class barring parameter (represented as P_{self}) corresponding to the (one or more) random access channel(s) provided by the base station 1 among the random access channels, or may determine all the access class barring parameters (represented as P=[p₁, . . . , p_{N}], where N is an integer greater than or equal to 2) corresponding to the random access channels based on load balance of the plurality of random access channels. For example, if the base station 1 only provides one random access channel with an corresponding access class barring parameter being p₁, and there are three other random access channels with three corresponding access class barring parameters being respectively p₂, p₃ and p₄, then P_{self} is just p₁ (i.e., P_{self}=p₁) and P includes p₁, p₂, p₃ and p₄ (i.e., P=[p₁, p₂, p₃, p₄]). In this example, if the base station 1 provides two random access channels, and the access class barring parameters corresponding to the two random access channels are respectively p₁ and p₂, then P_{self} includes p₁ and p₂ (i.e., P_{self}=[p₁, p₂]) and P includes p₁, p₂, p₃ and p₄ (i.e., P=[p₁, p₂, p₃, p₄]).

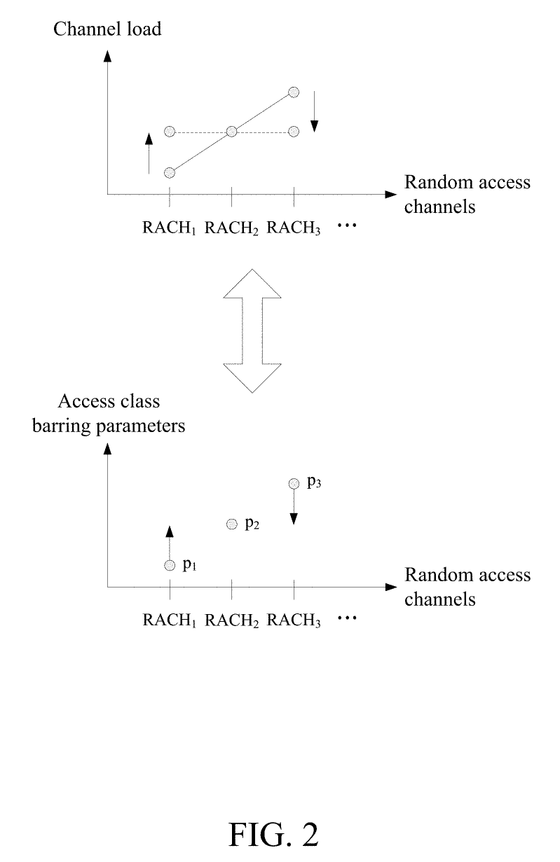

FIG. 2 illustrates relationships between the load balance of a plurality of random access channels and access class barring parameters according to one or more embodiments of the present invention. Referring to FIG. 2, it is assumed that the channel load of the plurality of random access channels is not balanced, e.g., the channel load of a random access channel RACH₁ is smaller than the channel load of a random access channel RACH₂, and the channel load of the random access channel RACH₂ is smaller than the channel load of a random access channel RACH₃. In this case, to achieve load balance, the processor 11 of the base station 1 may improve the channel load of the random access channel RACH₁ and reduce the channel load of the random access channel RACH₃ so that the channel loads of the three random access channels RACH₁, RACH₂ and RACH₃ tend to become balanced. The channel load may comprise various factors, for example but not limited to: the number of communication terminals using each random access channel, the delay time of data transmission on each random access channel, etc..

Generally, the higher the access barring extent of a random access channel is, the lower the probability that the random access channel is accessed will be; and the lower the probability that a random access channel is accessed is, the lower the channel load of the random access channel will be. Taking the access class barring mechanism proposed by the 3^{rd} Generation Partnership Project (3GPP) as an example, each access class barring parameter is a value (a probability value) ranging from 0 to 1, and is used as the access barring extent of the random access channel corresponding to the access class barring parameter. A higher value of the access class barring parameter means that the access value generated randomly by the communication terminal is more likely to be smaller than the access class barring parameter, i.e., the access barring extent of the random access channel corresponding to the access class barring parameter is lower.

As shown in FIG. 2, in order to improve the channel load of the random access channel RACH₁, the processor 11 of the base station 1 can enlarge the value of the access class barring parameter corresponding to the random access channel RACH₁, thereby making it easier for the communication terminal that can use the random access channel RACH₁ to access the random access channel RACH₁. In order to reduce the channel load of the random access channel RACH₃, the processor 11 of the base station 1 can decrease the value of the access class barring parameter corresponding to the random access channel RACH₃, thereby making it more difficult for the communication terminal that can use the random access channel RACH₃ to access the random access channel RACH₃.

The transceiver 93 of the communication terminal 9 may be configured to receive a plurality of access class barring parameters broadcasted by at least one base station (i.e., one or more base stations), each of the access class barring parameters corresponds to a random access channel, and each of the random access channels is created on a component carrier. The processor 91 of the communication terminal 9 may be configured to determine a random access channel candidate from the random access channels according to the access class barring parameters and perform a random access procedure on the random access channel candidate.

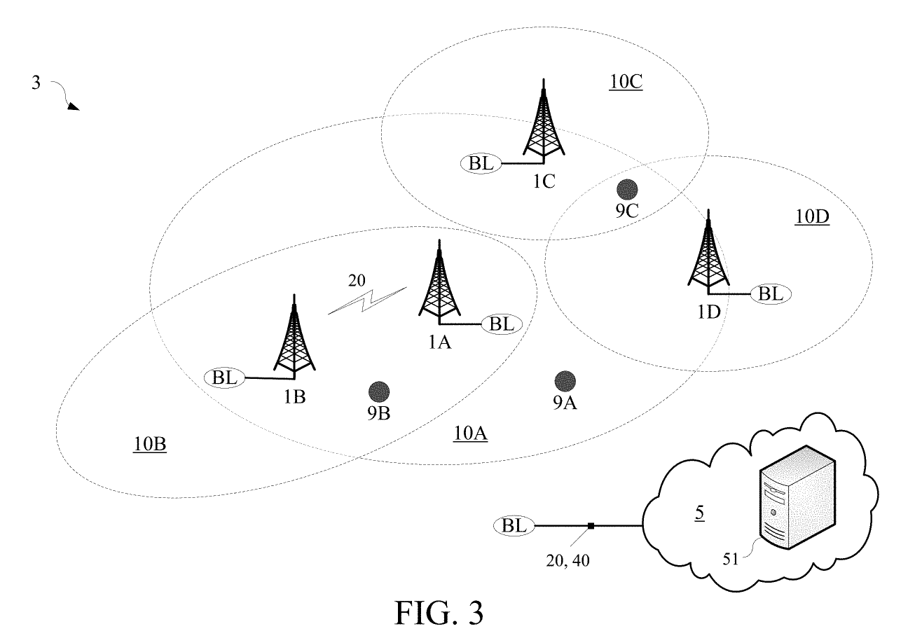

FIG. 3 illustrates a heterogeneous network communication system according to one or more embodiments of the present invention. The base station 1 and the communication terminal 9 will be further described hereinafter by taking FIG. 3 as an example; however, this example is not intended to limit the present invention. Referring to FIG. 3, a heterogeneous network communication system 3 comprises base stations 1A, 1B, 1C and 1D and communication terminals 9A, 9B and 9C. The coverages of the base stations 1A, 1B, 1C and 1D are respectively 10A, 10B, 10C and 10D.

The coverage 10A overlaps with each of the coverages 10B, 10C and 10D, and the coverage 10C overlaps with the coverage 10D. The communication terminal 9A is only located within the coverage 10A, the communication terminal 9B is located within the region where the coverage 10A overlaps with the coverage 10B, and the communication terminal 9C is located within the region where the coverage 10A overlaps with the coverage 10C and the coverage 10D.

In some embodiments, data transmission among the base stations 1A, 1B, 1C and 1D can be achieved through dedicated transmission interfaces (e.g., X2 interfaces) between the base stations. Additionally, in some embodiments, each of the base stations 1A, 1B, 1C and 1D may be connected with a core network 5 via the backhaul link BL thereof, and data transmission among the base stations 1A, 1B, 1C and 1D can be achieved through the core network 5. The core network 5 may comprise a core network apparatus 51. Like the base station 1, the core network apparatus 5 may be an apparatus having a computing apparatus and a transceiving apparatus, and the computing apparatus and the transceiving apparatus may be configured to perform the following operations of the core network apparatus 51.

In some embodiments, when the base station 1A is located within the coverage 10B of the base station 1B, and the base station 1B is also located within the coverage 10A of the base station 1A, the base station 1A can directly transmit data with the base station 1B (e.g., via wireless transmission), and vice versa.

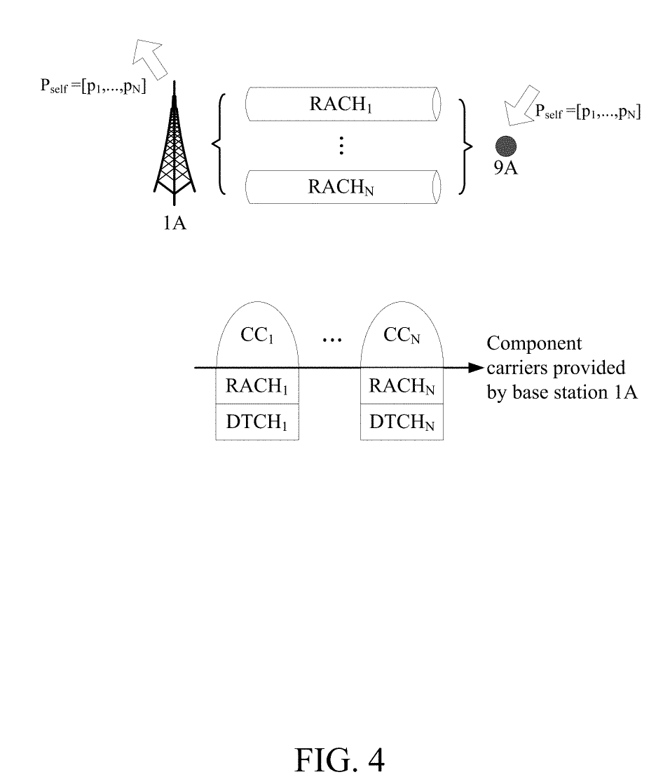

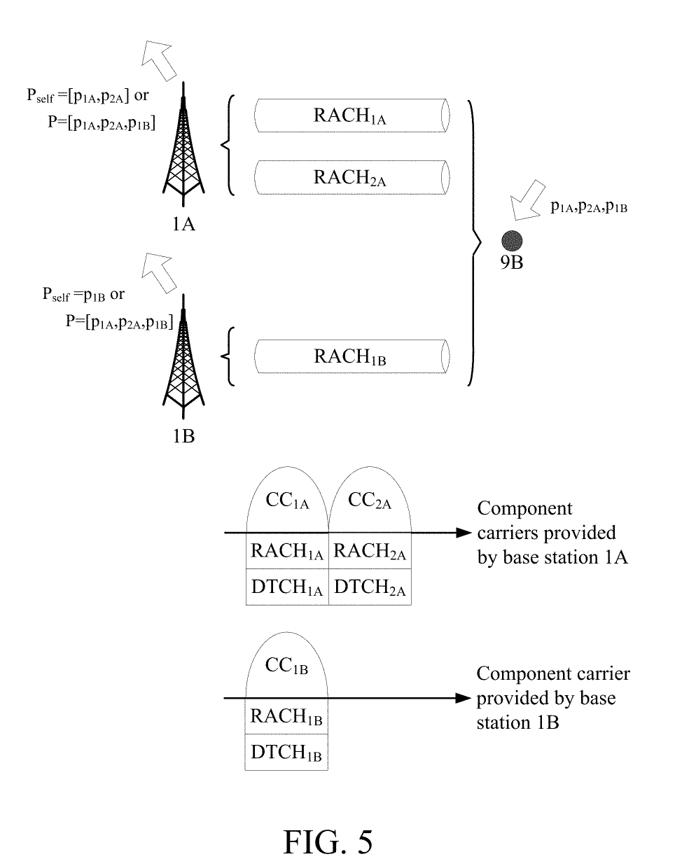

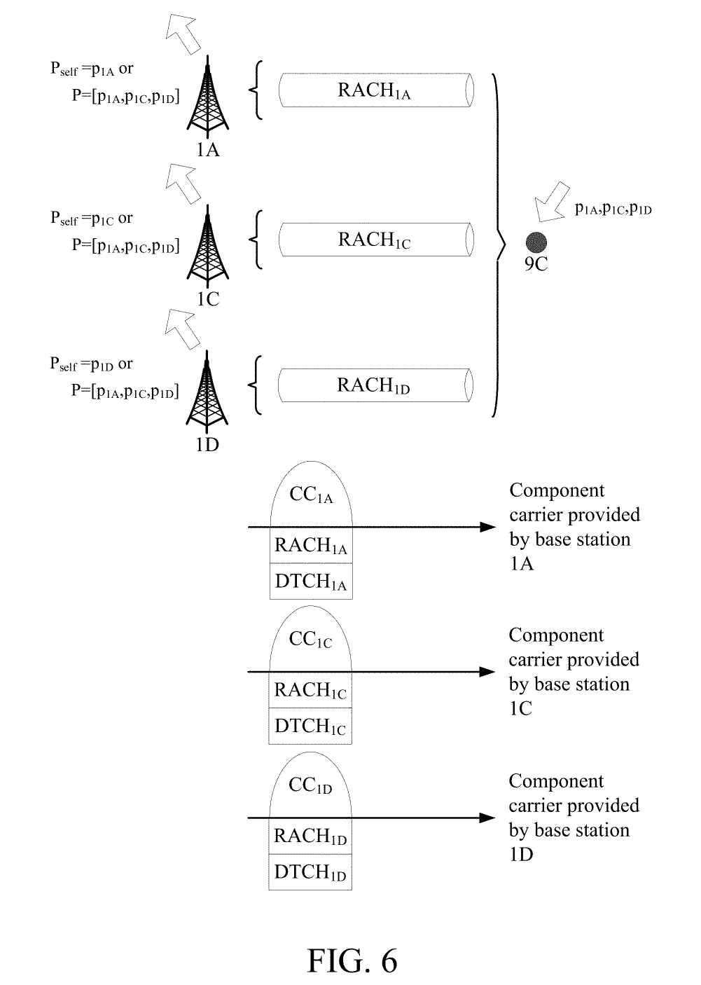

Referring to FIG. 1 and FIG. 3, the base station 1 may be any of the base stations 1A, 1B, 1C and 1D, and the communication terminal 9 may be any of the communication terminals 9A, 9B and 9C. Different operations under the heterogeneous network communication system 3 will be described hereinafter by taking FIG. 4, FIG. 5 and FIG. 6 as examples. FIG. 4 illustrates a random access mode between the base station 1A and the communication terminal 9A under the heterogeneous network communication system 3 according to one or more embodiments of the present invention.

FIG. 5 illustrates a random access mode between the base stations 1A and 1B and the communication terminal 9B under the heterogeneous network communication system 3 according to one or more embodiments of the present invention. FIG. 6 illustrates a random access mode between the base stations 1A, 1B and 1C and the communication terminal 9C under the heterogeneous network communication system 3 according to one or more embodiments of the present invention.

Referring to FIG. 4, it is assumed that the base station 1A can provide N component carriers (i.e., CC₁˜CC_{N}), and a random access channel can be created on each of the component carriers (i.e., RACH₁˜RACH_{N}) for use by the communication terminal 9A, where N is an integer greater than or equal to 2.

In some embodiments, the processor 11 of the base station 1A may determine N access class barring parameters according to N channel states 20 of the N random access channels based on the load balance of the N random access channels, and wherein the n^{th} access class barring parameter corresponds to the n^{th} random access channel, and n is an integer ranging from 1 to N. The N channel states 20 may provide relevant information about the channel load of the N random access channels, for example but not limited to: the number of communication terminals using each random access channel, the delay time of data transmission on each random access channel, or the like. Through the N channel states 20, the processor 11 of the base station 1A can evaluate the channel load of the N random access channels, and then determine the N access class barring parameters based on the load balance of the N random access channels. For example, as shown in FIG. 2, if the channel load of the first random access channel RACH₁ is greater than the channel load of the second random access channel RACH₂, and the channel load of the second random access channel RACH₂ is greater than the channel load of the third random access channel RACH₃, then the processor 11 of the base station 1A may increase the value of the first access class barring parameter p₁ and decrease the value of the third access class barring parameter p₃.

In some embodiments, the transceiver 13 of the base station 1A may transmit the N channel states 20 of the N random access channels to the core network apparatus 51 via the backhaul link BL. The core network apparatus 51 may calculate N default values 40 of the N access class barring parameters according to the N channel states 20 of the N random access channels based on the load balance of the N random access channels, and then transmits the N default values 40 to the base station 1A via the backhaul link BL. After the transceiver 13 of the base station 1A receives the N default values 40 of the N access class barring parameters from the core network apparatus 51, the processor 11 of the base station 1A can directly determine the N access class barring parameters according to the N default values 40. In some embodiments, this is equivalent to the case that the base station 1A directly uses values of the aforesaid N default values 40 transmitted by the core network apparatus 51 as the values of the aforesaid N access class barring parameters.

After determining the N access class barring parameters, the transceiver 13 of the base station 1A can broadcast N access class barring parameters (i.e., broadcast P_{self}=[p₁, . . . , p_{N}]) and N corresponding access class barring periods. The transceiver 93 of the communication terminal 9A may be configured to receive the N access class barring parameters broadcasted by the base station 1A, and the processor 91 of the communication terminal 9A may be configured to determine a random access channel candidate from the N random access channels according to the N access class barring parameters.

Further, after receiving the N access class barring parameters broadcasted by the base station 1A, the processor 91 of the communication terminal 9A can determine a probability value kₙ for each of the N random access channels, and wherein n is an integer ranging from 1 to N. Then, the processor 91 of the communication terminal 9A can determine the random access channel candidate according to the probability values, and wherein if a greater access class barring parameter represents a lower access barring extent (e.g., in the access class barring mechanism proposed by the 3GPP), then the probability value kₙ determined by the processor 91 for the random access channel corresponding to the greater access class barring parameter is greater.

For example, if the first access class barring parameter p₁ is greater than the second access class barring parameter p₂, and the second access class barring parameter p₂ is greater than the third access class barring parameter p₃, then it means that the access barring extent of the first random access channel RACH₁ is smaller than the access barring extent of the second random access channel RACH₂, and the access barring extent of the second random access channel RACH₂ is smaller than the access barring extent of the third random access channel RACH₃. At this point, a probability value k₁ set by the processor 91 of the communication terminal 9A for the first random access channel RACH₁ will be greater than a probability value k₂ set for the second random access channel RACH₂, and a probability value k₂ set for the second random access channel RACH₂ will be greater than a probability value k₃ set for the third random access channel RACH₃. In other words, the probability that the random access channel of a larger access barring extent is selected should be lower, and the probability that the random access channel of a smaller access barring extent is selected should be higher, and thereby the probability that the communication terminal 9A accesses the random channel of a smaller access barring extent is higher.

In some embodiments, a sum of the N probability values determined by the processor 91 of the communication terminal 9A for the N random access channels may be set to be less than or equal to 1, and each of the probability values may be set to be less than 1. Setting each of the probability values to be less than 1 is to prevent all the communication terminals (including the communication terminal 9A) under the coverage 10A from selecting the same random access channel all the time, i.e., selecting the random access channel corresponding to the probability value of 1 all the time.

After selecting a random access channel candidate from the N random access channels, the communication terminal 9A can perform a random access procedure on the random access channel candidate. The random access procedure may be a random access procedure based on an access class barring procedure. Taking the access class barring mechanism proposed by the 3GPP as an example, if the processor 91 of the communication terminal 9A selects the second random access channel RACH₂ as the random access channel candidate, then the processor 91 of the communication terminal 9A can randomly generate an access value (a value ranging from 0 to 1). If the access value randomly generated by the processor 91 is smaller than or equal to the second access class barring parameter p₂, then the probability that the communication terminal 9A accesses the base station 1A through the second random access channel RACH₂ is just the access value. If the access value is greater than the second access class barring parameter p₂, then the communication terminal 9A will have to wait for the access class barring period corresponding to the second access class barring parameter p₂ and then repeat the aforesaid operations.

After the communication terminal 9A accesses the base station 1A through the random access channel candidate, the processor 91 can perform a data transmission procedure on a data transmission channel. The data transmission channel may comprise a control channel and a data channel, and the data transmission procedure comprises various operations of transmitting control messages on the control channel and various operations of transmitting control messages on the data channel For example, the control channel may be a physical uplink control channel (PUCCH) or a physical downlink control channel (PDCCH), and the data channel may be a physical uplink shared channel (PDSCH) or a physical downlink shared channel (PDSCH).

In some embodiments, the data transmission channel and the random access channel candidate may be created on the same component carrier; while in some other embodiments, the data transmission channel and the random access channel candidate may be created on different component carriers. In other words, after the communication terminal 9A accesses the base station 1A through the random access channel candidate, the processor 91 can perform a data transmission procedure on a data transmission channel created on any component carrier.

For example, if the base station 1A creates the first random access channel RACH₁, the second random access channel RACH₂ and the third random access channel RACH₃ respectively on the first component carrier CC₁, the second component carrier CC₂ and the third component carrier CC₃, then the communication terminal 9A can select any of a first data transmission channel DTCH₁ (created on the first component carrier CC₁), a second data transmission channel DTCH₂ (created on the second component carrier CC₂) and a third data transmission channel DTCH₃ (created on the third component carrier CC₃) to perform a data transmission procedure after the communication terminal 9A accesses the base station 1A through the second random access channel RACH₂.

Referring to FIG. 5, it is assumed that the base station 1A can provide two component carriers (i.e., CC_{1A} and CC_{2A}), and create random access channels (i.e., RACH_{1A} and RACH_{2A}) respectively on the component carriers CC_{1A} and CC_{2A} for use by the communication terminal 9B. Additionally, it is assumed that the base station 1B can provide one component carrier (i.e., CC_{1B}), and create a random access channel (i.e., RACH_{1B}) on the component carrier CC_{1B} for use by the communication terminal 9B. Different from FIG. 4, in FIG. 5, a plurality of base stations provide a plurality of random access channels for use by a communication terminal.

In some embodiments, the processor 11 of at least one of the base station 1A and the base station 1B may determine access class barring parameters p_{1A}, p_{2A} and p_{1B} according to three channel states 20 of the aforesaid three random access channels (i.e., RACH_{1A}, RACH_{2A} and RACH_{1B}) based on the load balance of the three random access channels. The way in which the access class barring parameters p_{1A}, p_{2A} and p_{1B} are determined herein may be the same as the way in which the N access class barring parameters are determined in the above description (reference may be made to the above description of FIG. 4). The base station 1A may communicate the channel states 20 of the random access channels RACH_{1A} and RACH_{2A} with the base station 1B via the transceiver 13, and the base station 1B may communicate the channel state 20 of the random access channel RACH_{1B} with the base station 1A via the transceiver 13. The communication between the base station 1A and the base station 1B may be implemented via at least one of: dedicated transmission interfaces (e.g., X2 interfaces) between the base stations, the backhaul link BL and the core network 5, and wireless communication.

In some embodiments, the transceiver 13 of the base station 1A may transmit the channel states 20 of the random access channels RACH_{1A} and RACH_{2A} to the core network apparatus 51 via the backhaul link BL, and the transceiver 13 of the base station 1B may also transmit the channel state 20 of the random access channel RACH_{1B} to the core network apparatus 51 via the backhaul link BL. The core network apparatus 51 may calculate default values 40 of the access class barring parameters p_{1A}, p_{2A} and p_{1B} respectively according to the channel states 20 of the random access channels RACH_{1A}, RACH_{2A} and RACH_{1B} based on the load balance of the random access channels RACH_{1A}, RACH_{2A} and RACH_{1B}.

The core network apparatus 51 may only transmit the default values 40 of the access class barring parameters p_{1A} and p_{2A} to the base station 1A, and only transmit the default value 40 of the access class barring parameter p_{1B} to the base station 1B. In this way, the processor 11 of the base station 1A can directly determine the access class barring parameters p_{1A} and p_{2A} according to the default values 40 of the access class barring parameters p_{1A} and p_{2A}, and then the transceiver 13 of the base station 1A can broadcast the access class barring parameters p_{1A} and p_{2A} and the two corresponding access class barring periods. Similarly, the processor 11 of the base station 1B can directly determine the access class barring parameters p_{1B} according to the default value 40 of the access class barring parameters p_{1B}, and then the transceiver 13 of the base station 1B can broadcast the access class barring parameter p_{1B} and one corresponding access class barring period.

The core network apparatus 51 may also together transmit the default values 40 of the three access class barring parameters p_{1A}, p_{2A} and p_{1B} to the base station 1A and the base station 1B. In this way, the processor 11 of at least one of the base station 1A and the base station 1B can directly determine the access class barring parameters p_{1A}, p_{2A} and p_{1B} according to the default values 40 of the three access class barring parameters p_{1A}, p_{2A} and P_{1B}, and then the transceiver 13 can broadcast the access class barring parameters p_{1A}, p_{2A} and p_{1B}.

The transceiver 93 of the communication terminal 9B may be configured to receive the access class barring parameters p_{1A}, p_{2A} and p_{1B} broadcasted by the base station 1A and the base station 1B, and the processor 91 of the communication terminal 9B may be configured to determine a random access channel candidate from the random access channels RACH_{1A}, RACH_{2A} and RACH_{1B} according to the access class barring parameters p_{1A}, p_{2A} and p_{1B}, and perform a random access procedure on the random access channel candidate. The way in which the communication terminal 9B determines the random access channel candidate and performs the random access procedure herein may be the same as the way in which the communication terminal 9A determines the random access channel candidate and performs the random access procedure in the above description (reference may be made to the above description of FIG. 4).

After performing the random access procedure, the communication terminal 9B may also perform a data transmission procedure on a data transmission channel, and the data transmission channel and the random access channel candidate may be created on the same component carrier or created on different component carriers. The way in which the communication terminal 9B performs the data transmission procedure herein may be the same as the way in which the communication terminal 9A performs the data transmission procedure in the above description (reference may be made to the above description of FIG. 4).

Referring to FIG. 6, it is assumed that the base station 1A can provide one component carrier (i.e., CC_{1A}), and create a random access channel (i.e., RACH_{1A}) on the component carrier CC_{1A} for use by the communication terminal 9C. It is assumed that the base station 1C can also provide one component carrier (i.e., CC_{1C}), and create a random access channel (i.e., RACH_{1C}) on the component carrier CC_{1C} for use by the communication terminal 9C. Additionally, it is assumed that the base station 1D can also provide one component carrier (i.e., CC_{1D}), and create a random access channel (i.e., RACH_{1D}) on the component carrier CC_{1D} for use by the communication terminal 9C. Different from FIG. 4, in FIG. 6, a plurality of base stations provide a plurality of random access channels for use by a communication terminal.

In some embodiments, the processor 11 of at least one of the base station 1A, the base station 1C and the base station 1D may determine access class barring parameters p_{1A}, p_{1C} and p_{1B} according to three channel states 20 of the aforesaid three random access channels (i.e., RACH_{1A}, RACH_{1C} and RACH_{1B}) based on the load balance of the three random access channels. The way in which the access class barring parameters p_{1A}, p_{1C} and p_{1B} are determined herein may be the same as the way in which the N access class barring parameters are determined in the above description (reference may be made to the above description of FIG. 4). The base station 1A may communicate the channel state 20 of the random access channel RACH_{1A} with the base station 1C and the base station 1D via the transceiver 13 thereof, the base station 1C may communicate the channel state 20 of the random access channel RACH_{1C} with the base station 1A and the base station 1D via the transceiver 13 thereof, and the base station 1D may communicate the channel state 20 of the random access channel RACH_{1D} with the base station 1A and the base station 1C via the transceiver 13 thereof. The communication between the base station 1A, the base station 1C and the base station 1D may be implemented via at least one of: dedicated transmission interfaces (e.g., X2 interfaces) between the base stations, the backhaul link BL and the core network 5.

In some embodiments, the transceiver 13 of the base station 1A may transmit the channel state 20 of the random access channel RACH_{1A} to the core network apparatus 51 via the backhaul link BL, the transceiver 13 of the base station 1C may transmit the channel state 20 of the random access channel RACH_{1C} to the core network apparatus 51 via the backhaul link BL, and the transceiver 13 of the base station 1D may also transmit the channel state 20 of the random access channel RACH_{1D} to the core network apparatus 51 via the backhaul link BL. The core network apparatus 51 may calculate default values 40 of the access class barring parameters p_{1A}, p_{1C} and p_{1D} respectively according to the channel states 20 of the random access channels RACH_{1A}, RACH_{1C} and RACH_{1D} based on the load balance of the random access channels RACH_{1A}, RACH_{1C} and RACH_{1D}.

The core network apparatus 51 may only transmit the default value 40 of the access class barring parameters p_{1A} to the base station 1A, only transmit the default value 40 of the access class barring parameter p_{1C} to the base station 1C, and only transmit the default value 40 of the access class barring parameter p_{1B} to the base station 1D. In this way, the processor 11 of the base station 1A can directly determine the access class barring parameter p_{1A} according to the default value 40 of the access class barring parameters p_{1A}, and then the transceiver 13 of the base station 1A can broadcast the access class barring parameter p_{1A} and one corresponding access class barring period. Similarly, the base station 1C can determine and broadcast the access class barring parameter p_{1C} and one corresponding access class barring period, and the base station 1D can determine and broadcast the access class barring parameter p_{1D} and one corresponding access class barring period.

The core network apparatus 51 may also together transmit the default values 40 of the three access class barring parameters p_{1A}, p_{1C} and p_{1D} to the base station 1A, the base station 1C and the base station 1D. In this way, the processor 11 of at least one of the base station 1A, the base station 1C and the base station 1D can directly determine the access class barring parameters p_{1A}, p_{1C} and p_{1B} according to the default values 40 of the three access class barring parameters p_{1A}, p^{1C} and p_{1D}, and then the transceiver 13 can broadcast the access class barring parameters p_{1A}, p_{1C} and p_{1D}.

The transceiver 93 of the communication terminal 9C may be configured to receive the access class barring parameters p_{1A}, p_{1C} and p_{1D} broadcasted by the base station 1A, the base station 1C and the base station 1D, and the processor 91 of the communication terminal 9C may be configured to determine a random access channel candidate from the random access channels RACH_{1A}, RACH_{1C} and RACH_{1D} according to the access class barring parameters p_{1A}, p_{1C} and p_{1B}, and perform a random access procedure on the random access channel candidate. The way in which the communication terminal 9C determines the random access channel candidate and performs the random access procedure herein may be the same as the way in which the communication terminal 9A determines the random access channel candidate and performs the random access procedure in the above description (reference may be made to the above description of FIG. 4).

After performing the random access procedure, the communication terminal 9C may also perform a data transmission procedure on a data transmission channel, and the data transmission channel and the random access channel candidate may be created on the same component carrier or created on different component carriers. The way in which the communication terminal 9C performs the data transmission procedure herein may be the same as the way in which the communication terminal 9A performs the data transmission procedure in the above description (reference may be made to the above description of FIG. 4).

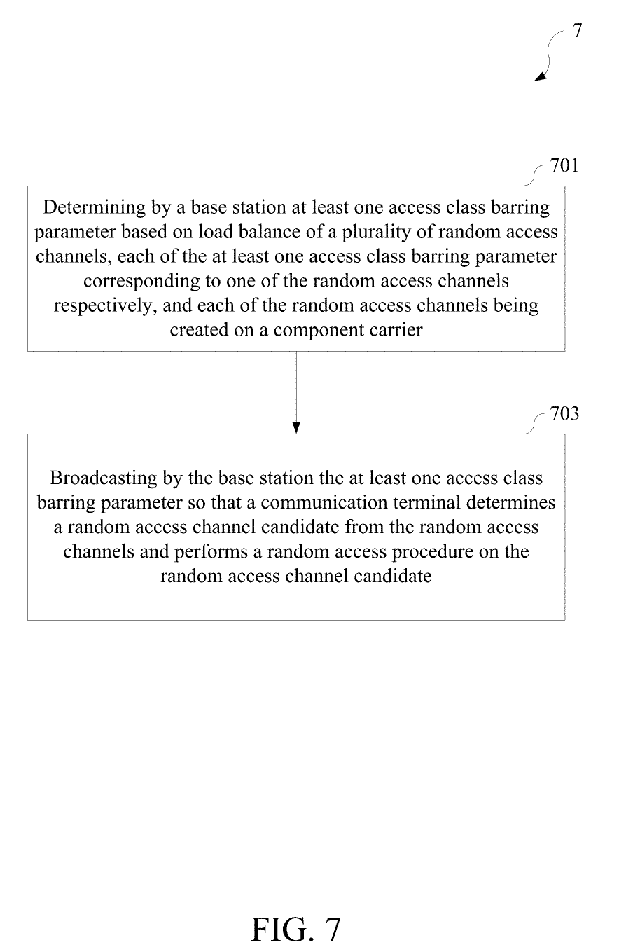

FIG. 7 illustrates an access class barring method according to one or more embodiments of the present invention. Referring to FIG. 7, an access class barring method 7 may comprise the following steps of: determining by a base station at least one access class barring parameter based on load balance of a plurality of random access channels, each of the at least one access class barring parameter corresponding to one of the random access channels respectively, and each of the random access channels being created on a component carrier (labeled as 701); and broadcasting by the base station the at least one access class barring parameter so that a communication terminal determines a random access channel candidate from the random access channels and performs a random access procedure on the random access channel candidate (labeled as 703).

In some embodiments, the step of determining the at least one access class barring parameter further comprises: determining by the base station the at least one access class barring parameter according to channel states of the random access channels.

In some embodiments, the step of determining the at least one access class barring parameter may further comprise: determining by the base station the at least one access class barring parameter according to channel states of the random access channels. Additionally, the component carriers may be provided by the base station.

In some embodiments, the step of determining the at least one access class barring parameter may further comprise: determining by the base station the at least one access class barring parameter according to channel states of the random access channels. Additionally, the component carriers may be provided by the base station and at least one other base station, and the access class barring method 7 may further comprise the following step of: communicating by the base station the channel states with the at least one other base station.

In some embodiments, the step of determining the at least one access class barring parameter further comprises: receiving by the base station a default value of the at least one access class barring parameter from a core network apparatus, and determining the at least one access class barring parameter according to the default value.

In some embodiments, the step of determining the at least one access class barring parameter further comprises: receiving by the base station a default value of the at least one access class barring parameter from a core network apparatus, and determining the at least one access class barring parameter according to the default value. Additionally, the component carriers may be provided by the base station.

In some embodiments, the step of determining the at least one access class barring parameter further comprises: receiving by the base station a default value of the at least one access class barring parameter from a core network apparatus, and determining the at least one access class barring parameter according to the default value. Additionally, the component carriers may be provided by the base station and at least one other base station.

The access class barring method 7 may be applied to the base stations 1, 1A, 1B, 1C and 1D, and accomplish the aforesaid various operations of the base stations 1, 1A, 1B, 1C and 1D. It shall be readily appreciated by those of ordinary skill in the art based on the above descriptions of the base stations 1, 1A, 1B, 1C and 1D regarding how the access class barring method 7 accomplishes the corresponding steps of these operations, and thus will not be further described herein.

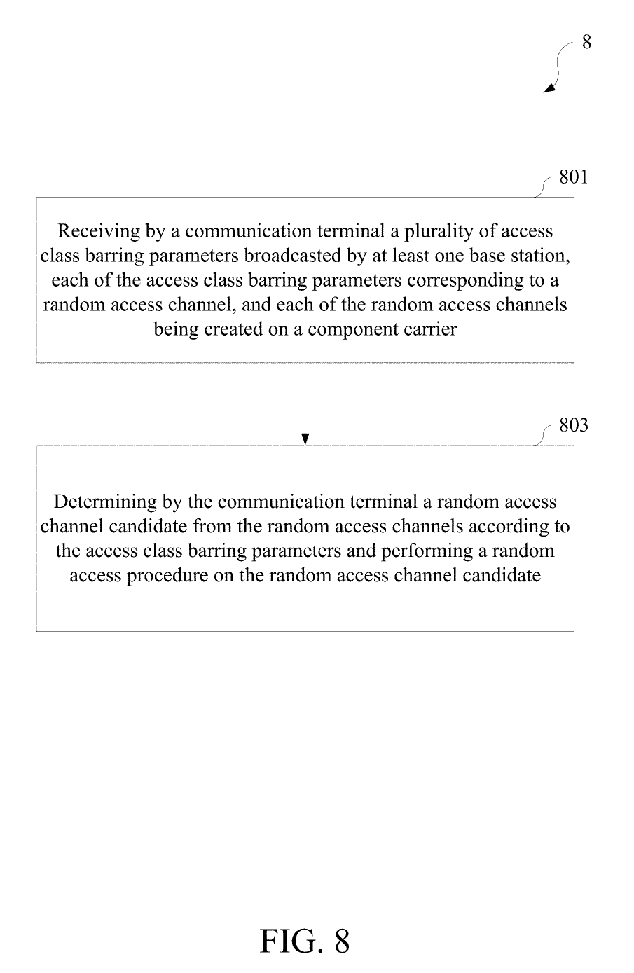

FIG. 8 illustrates a random access method according to one or more embodiments of the present invention. Referring to FIG. 8, a random access method 8 may comprise the following steps: receiving by a communication terminal a plurality of access class barring parameters broadcasted by at least one base station, each of the access class barring parameters corresponding to a random access channel, and each of the random access channels being created on a component carrier (labeled as 801); and determining by the communication terminal a random access channel candidate from the random access channels according to the access class barring parameters and performing a random access procedure on the random access channel candidate (labeled as 803).

In some embodiments, the processor may further determine a probability value for each of the random access channels and determine the random access channel candidate according to the probability values, and wherein if a greater access class barring parameter represents a lower access barring extent, then the probability value determined by the processor for the random access channel corresponding to the greater access class barring parameter is greater.

In some embodiments, the processor may further determine a probability value for each of the random access channels and determine the random access channel candidate according to the probability values, and wherein if a greater access class barring parameter represents a lower access barring extent, then the probability value determined by the processor for the random access channel corresponding to the greater access class barring parameter is greater. Additionally, a sum of the probability values may be less than or equal to 1, and each of the probability values may be less than 1.

In some embodiments, the processor may further perform a data transmission procedure on a data transmission channel after performing the random access procedure, and the data transmission channel is created on a component carrier different from that of the random access channel candidate

In some embodiments, the processor may further perform a data transmission procedure on a data transmission channel after performing the random access procedure, and the data transmission channel is created on the same component carrier as that of the random access channel candidate.

In some embodiments, the random access procedure may be a random access procedure based on an access class barring procedure.

The random access method 8 may be applied to the communication terminals 9, 9A, 9B and 9C, and accomplish the aforesaid various operations of the communication terminals 9, 9A, 9B and 9C. It shall be readily appreciated by those of ordinary skill in the art based on the above descriptions of the communication terminals 9, 9A, 9B and 9C regarding how the random access method 8 accomplishes the corresponding steps of these operations, and thus will not be further described herein.

According to the above descriptions, unlike each base station of the conventional access class barring mechanism that can only broadcast one access class barring parameter corresponding to the random access channel provided by itself, the base station and the access class barring method thereof according to the present invention can determine and broadcast at least one (i.e., one or more) access class barring parameter, and each of the at least one access class barring parameter is determined based on load balance of a plurality of random access channels. On the other hand, unlike each communication terminal of the conventional access class barring mechanism that can only perform a random access procedure on a random access channel provided by a single base station that is serving the communication terminal, the communication terminal and the random accessing method thereof according to the present invention can determine a random access channel candidate from a plurality of random access channels according to a plurality of access class barring parameters broadcasted by at least one base station (i.e., one or more base stations), and then perform a random access procedure on the random access channel candidate. Because the present invention can handle traffic congestions of a plurality of random access channels as a whole, the problem that the conventional access class barring mechanism can only handle traffic congestions of a single random access channel provided by an individual base station can be effectively solved.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A base station, comprising:
a processor, being configured to determine at least one access class barring parameter based on load balance of a plurality of random access channels, each of the at least one access class barring parameter corresponding to one of the random access channels respectively, and each of the random access channels being created on a component carrier; and
a transceiver, being configured to broadcast the at least one access class barring parameter so that a communication terminal determines a random access channel candidate from the random access channels and performs a random access procedure on the random access channel candidate.

2. The base station according to claim 1, wherein the processor determines the at least one access class barring parameter according to channel states of the random access channels.

3. The base station according to claim 2, wherein the component carriers are provided by the base station.

4. The base station according to claim 2, wherein the component carriers are provided by the base station and at least one other base station, and the transceiver further communicates the channel states with the at least one other base station.

5. The base station according to claim 1, wherein the transceiver receives a default value of the at least one access class barring parameter from a core network apparatus, and the processor determines the at least one access class barring parameter according to the default value.

6. The base station according to claim 5, wherein the component carriers are provided by the base station.

7. The base station according to claim 5, wherein the component carriers are provided by the base station and at least one other base station.

8. An access class barring method, comprising:
determining by a base station at least one access class barring parameter based on load balance of a plurality of random access channels, each of the at least one access class barring parameter corresponding to one of the random access channels respectively, and each of the random access channels being created on a component carrier; and
broadcasting by the base station the at least one access class barring parameter so that a communication terminal determines a random access channel candidate from the random access channels and performs a random access procedure on the random access channel candidate.

9. The access class barring method according to claim 8, wherein the step of determining the at least one access class barring parameter further comprises: determining by the base station the at least one access class barring parameter according to channel states of the random access channels.

10. The access class barring method according to claim 9, wherein the component carriers are provided by the base station.

11. The access class barring method according to claim 9, wherein the component carriers are provided by the base station and at least one other base station, and the access class barring method further comprises the following step of: communicating by the base station the channel states with the at least one other base station.

12. The access class barring method according to claim 8, wherein the step of determining the at least one access class barring parameter further comprises: receiving by the base station a default value of the at least one access class barring parameter from a core network apparatus, and determining the at least one access class barring parameter according to the default value.

13. The access class barring method according to claim 12, wherein the component carriers are provided by the base station.

14. The access class barring method according to claim 12, wherein the component carriers are provided by the base station and at least one other base station.

15. A communication terminal, comprising:
a transceiver, being configured to receive a plurality of access class barring parameters broadcasted by at least one base station, each of the access class barring parameters corresponding to a random access channel, and each of the random access channels being created on a component carrier; and
a processor, being configured to determine a random access channel candidate from the random access channels according to the access class barring parameters and perform a random access procedure on the random access channel candidate.

16. The communication terminal according to claim 15, wherein the processor further determines a probability value for each of the random access channels and determines the random access channel candidate according to the probability values, and wherein if a greater access class barring parameter represents a lower access barring extent, then the probability value determined by the processor for the random access channel corresponding to the greater access class barring parameter is greater.

17. The communication terminal according to claim 16, wherein a sum of the probability values is less than or equal to 1, and each of the probability values is less than 1.

18. The communication terminal according to claim 15, wherein the processor further performs a data transmission procedure on a data transmission channel after performing the random access procedure, and the data transmission channel is created on a component carrier different from that of the random access channel candidate.

19. The communication terminal according to claim 15, wherein the processor further performs a data transmission procedure on a data transmission channel after performing the random access procedure, and the data transmission channel is created on the same component carrier as that of the random access channel candidate.

20. The communication terminal according to claim 15, wherein the random access procedure is a random access procedure based on an access class barring procedure.
